(19) United States
(12) Patent Application Publication
(10) Pub. No.: US 2005/0275336 A1
(43) Pub. Date: Dec. 15, 2005

(54) Field emission device and method for making same

(75) Inventors: Yang Wei, Beijing (CN); Liang Liu, Beijing (CN); Shou-Shan Fan, Beijing (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignees: Tsinghua University, Beijing City (CN); HON HAI Precision Industry CO., LTD., Tu-Cheng City (TW)

(21) Appl. No.: 11/142,075

(22) Filed: Jun. 1, 2005

(30) Foreign Application Priority Data
Jun. 11, 2004 (CN) 200410027653.5

(51) Int. Cl. H01J 1/62; H01J 63/04

(52) U.S. Cl. 313/495

(57) ABSTRACT

A field emission device (5) includes cathodes (51), emitters (52) formed on the cathodes, grid electrodes (54) formed over the cathodes at a distance apart from the emitters respectively, and an isolated film (55) formed on first surfaces of each two neighboring grid electrodes. Preferably, the isolated film has a thickness ranging from 0.1 to 1 microns. The isolated film may be a film made of one or more insulating materials, such as SiO₂ and Si₃N₄. Alternatively, the one or more insulating materials can be selected from a material having a high secondary electron emission coefficient, such as MgO, Al₂O₃, and ZnO. Additionally, the isolated film can be further formed on a second surface of the grid electrode apart from the emitter.

### CROSS-REFERENCE TO RELATED APPLICATIONS

This application is related to a U.S. patent application filed recently and entitled “FIELD EMISSION DEVICE AND METHOD FOR MAKING SAME” with the same assignee. The disclosure of the above identified application is incorporated herein by reference.

### BACKGROUND

1. Field of the Invention

The present invention relates to a field emission device and a method for making the field emission device, and more particularly to a field emission device having grid electrodes.

2. Background

Field emission devices are based on emission of electrons in a vacuum in order to produce emission of light. Electrons are emitted from micron-sized tips in a strong electric field, and the electrons are accelerated and collide with a fluorescent material. Field emission devices are thin and light, and provide high brightness.

Diode field emission devices having a conventional structure can be easily manufactured. However, they are disadvantageous in controlling emission current and realizing a moving picture or a gray-scale picture. Accordingly, instead of a diode structure, a triode structure is commonly required.

Referring to FIG. 3, a typical triode field emission device 4 includes a cathode electrode 40, an anode electrode 45, and a plurality of strip-shaped grid electrodes 43 located therebetween. A vacuum chamber between the cathode electrode 40 and the anode electrode 45 is maintained by several spacers 44. The cathode electrode 40 has a plurality of fine emitters 41 formed thereon. Generally, an insulating layer 42 is arranged between the cathode electrode 40 and the grid electrodes 43, electrically isolating the cathode electrode 40 and the grid electrodes 43. The insulating layer 42 includes a plurality of tiny through holes corresponding to the emitters 41. The grid electrodes 43 are arranged on a top surface of the insulating layer 42, for extracting electrons from the emitters 41.

During a process of manufacturing a triode field emission device, the working area may not be perfectly clean. There is a risk of a plurality of conductive particles being deposited on the insulating layer 42 between the two neighboring grid electrodes 43. An interval distance between the two neighboring grid electrodes 43 is generally very small. Consequently, the two neighboring grid electrodes 43 can easily be short-circuited. This degrades operation of the field emission device, and may even lead to complete failure thereof.

### SUMMARY

In one aspect of the present invention, there is provided a field emission device which includes a cathode electrode, a plurality of emitters formed on the cathode electrode, a plurality of grid electrodes formed over the cathode electrode at a distance apart from the emitters respectively, and an isolated film formed on first surfaces of each two neighboring grid electrodes.

Preferably, the isolated film has a thickness ranging from 0.1 to 1 microns. The isolated film may be a film made of one or more insulating materials, such as SiO₂ and Si₃N₄. Alternatively, the one or more insulating materials can be selected from a material having a high secondary electron emission coefficient, such as MgO, Al₂O₃ and ZnO. Additionally, the isolated film can be further formed on a second surface of the grid electrode apart from the emitter.

A material of the emitter can be selected from carbon nanotubes, diamond, diamond-like carbon (DLC), and silicon, or the emitter can be made of a tip-shaped metal material.

The field emission device may further include an insulating layer between the cathode electrode and the grid electrode. Further, the isolated film is formed on a surface of the insulating layer between the two neighboring grid electrodes.

The field emission device may further include an anode electrode formed over the grid electrode and facing the cathode electrode.

In another aspect of the present invention, there is provided a method for making a field emission device having a cathode electrode, a plurality of emitters formed on the cathode electrode, and a plurality of grid electrodes formed over the cathode electrode at a distance apart from the emitters respectively, which includes the step of: forming an isolated film on first surfaces of each two neighboring grid electrodes facing each other.

Preferably, the forming step is performed by way of evaporation. The evaporation can further include the step of spinning the grid electrode. Preferably, evaporated molecules of the material of the isolated films shoot at a surface of the grid electrode at an oblique angle.

These and other features, aspects and advantages will become more apparent from the following detailed description and claims, and the accompanying drawings.

### BRIEF DESCRIPTION OF THE DRAWINGS

FIG. 1 is a schematic, simplified, cross-sectional view of a field emission device in accordance with a first embodiment of the present invention.

FIG. 2 is a schematic, cross-sectional view of part of a field emission cathode device in accordance with an alternative embodiment of the present invention.

FIG. 3 is a schematic, simplified, cross-sectional view of a conventional triode field emission device.

### DETAILED DESCRIPTION OF THE PREFERRED EMBODIMENTS

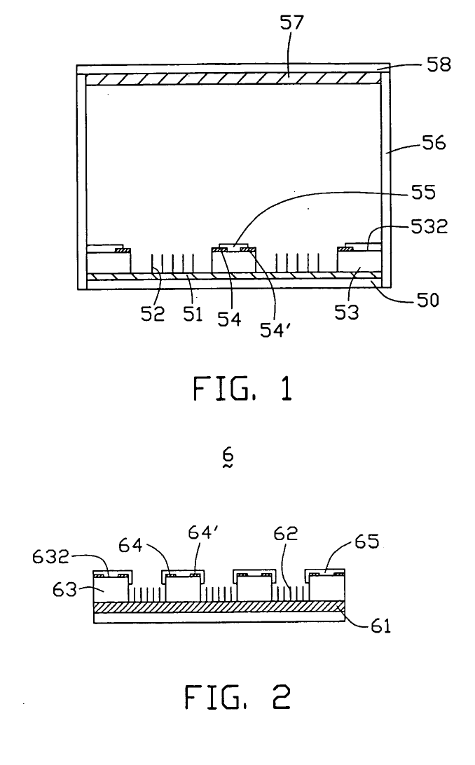

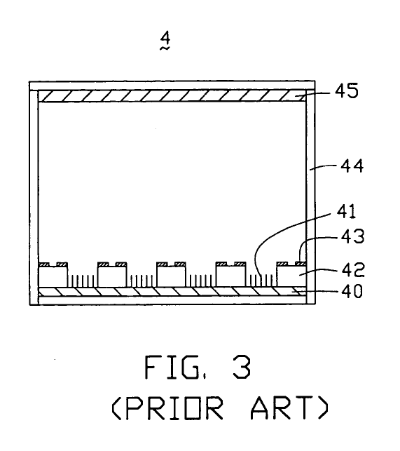

With reference to FIG. 1, there is shown a field emission display 5 in accordance with a first embodiment of the present invention. The field emission display 5 comprises a front substrate 58 and a rear substrate 50 facing thereto. The front substrate 58 is separated from the rear substrate 50 by several spacers 56 arranged therebetween. A chamber maintained by the spacers 56 between the front substrate 58 and the rear substrate 50 is preferably a vacuum. A plate-like anode electrode 57 is disposed on a surface of the front substrate 58 facing the rear substrate 50. Cathode electrodes 51 are disposed in parallel strips on an anode-facing surface of the rear substrate 50. A plurality of electron emitters 52 are formed on predetermined portions of the cathodes 51, the electron emitters 52 being electrically connect with the cathodes 51. An insulating layer 53 is located on the cathodes 51. The insulating layer 53 defines a plurality of first through holes corresponding to the emitters 52, for exposing the emitters 52 to the anode 57. Grid electrodes 54, 54′ are formed in parallel strips on an anode-facing surface of the insulating layer 53, the grid electrodes 54, 54′ being arranged crosswise relative to the cathodes 51. Each of the grid electrodes 54, 54′ is separated a distance from the emitters 52, and the grid electrodes 54, 54′ define a plurality of second through holes corresponding to the emitters 52. An isolated film 55 is commonly formed on surfaces of each two neighboring grid electrodes 54, 54′. Accordingly, part of each isolated film 55 also covers a corresponding surface 532 of the insulating layer 53 that lies between the two neighboring grid electrodes 54, 54′.

Alternatively, each isolated film 55 can extend to cover emitter-neighboring surfaces of the grid electrodes 54, 54′. In particular, the isolated film 55 can cover surfaces of the grid electrodes 54, 54′ that serve as inner walls of the second through holes.

In operation, a proportion of electrons emitted from the emitters 52 at relative large angles shoot at the grid electrodes 54, 54′, due to the attraction thereof. Because of the coating of the isolated films 55 on the grid electrodes 54, 54′, most of the electrons cannot directly reach surfaces of the grid electrodes 54, 54′, and instead change their emitting angles toward the anode 57 after hitting the isolated films 55. As a result, the number of electrons captured by the grid electrodes 54, 54′ is significantly reduced. A more efficient use of the emitting electrons is accordingly obtained.

In the first embodiment, the isolated films 55 are made of one or more insulating materials, such as SiO₂ and/or Si₃N₄. Alternatively, the insulating materials may be one or more materials having a high secondary electron emission coefficient, such as MgO, Al₂O₃, and/or ZnO. Consequently, the isolated films 55 may emit electrons when they are subjected to the collisions by the electrons emitted from the cathodes 51. Therefore, a current of emitting electrons is increased, and the efficiency of the field emission display 5 can be improved. Thicknesses of the isolated films 55 are minimal, so that the isolated films 55 do not materially affect the electrical field between the cathodes 51 and the grid electrodes 54, 54′. Preferably, each of the isolated films 55 has a thickness ranging from 0.1 to 1 microns.

A material of the emitters 52 is selected from electrical conductors such as carbon-based materials, and may, for example, be carbon nanotubes, diamond, diamond-like carbon (DLC), or silicon. Alternatively, the emitters 52 can be silicon tips or metal tips.

The anode 57 is a conductive layer formed on the front substrate 58, and is generally made of indium-tin oxide. Fluorescent layers (not shown) are formed in strips on an emitter-facing surface of the anode 57. The cathodes 51 are made of Ag, Cu, or other conductive metal materials.

In a process for manufacturing the field emission display 5, the cathodes 51 are screen-printed on a glass plate that serves as the rear substrate 50. An insulating material is deposited on the top surfaces of the cathodes 51, thereby forming the insulating layer 53. The insulating layer 53 is etched to form the first through holes, and parts of surfaces of the cathodes 51 corresponding to the first through holes are exposed. The emitters 52 are patterned on the exposed surfaces of the cathodes 51, and are formed by chemical vapor deposition. Alternatively, films containing a material of the emitters 52 made in advance are arranged on the cathodes 51, with the emitters 52 being formed by a sol-gel process or by gluing thereon. The grid electrodes 54, 54′ are formed in parallel strips on parts of surfaces of the insulating layer 53, such that the grid electrodes 54, 54′ cross the cathodes 51. This formation is performed by way of a screen-printing process. The grid electrodes 54, 54′ are then etched to form the second through holes.

A material of the isolated films 55 is evaporated on each two neighboring grid electrodes 54, 54′ and the surface 532 of the insulating layer 53 therebetween, to thereby form the isolated films 55. Preferably, during the evaporation, the grid electrodes 54, 54′ are spun, and evaporated molecules of the material of the isolated films 55 are driven to shoot at the surfaces of the grid electrodes 54, 54′ at one or more oblique angles. The oblique angle is selected according to desired parameters, such as diameters and locations of the first and second through holes, so that the emitters 52 are secured to be exposed to the anode 57.

The anode 57 is formed on a glass plate serving as the front substrate 58, by depositing indium-tin oxide on the front substrate 58. A fluorescent material is patterned on predetermined regions of the anode 57 facing the emitters 52, to form the fluorescent layer. Spacers 56 are interposed between the rear substrate 50 and the front substrate 58. Air between the rear substrate 50 and the front substrate 58 is drawn out therefrom by a pump to form a substantial vacuum. After some encapsulating procedures, the field emission display 5 is thereby formed.

Alternatively, the anode 57 can be formed in parallel strips, and the cathodes 51 and grid electrodes 54, 54′ can be formed as two continuous surfaces respectively. The cathodes 51 and grid electrodes 54, 54′ can be formed in strips by deposition and photolithography/etching. In addition, molding plates corresponding to the cathodes 51, the insulating layer 53 and the grid electrodes 54, 54′ can be made in advance and applied in the field emission display 5 respectively. A manufacturing sequence of components between the front substrate 58 and the rear substrate 50 can be re-arranged, and should not be construed to be limited by the first embodiment.

It is noted that how to manufacture a part of the field emission display 5, such as the cathodes 51, the insulating layer 53, the grid electrodes 54, 54′, or the anode 57, and how to encapsulate a field emission display can be referenced in U.S. Pat. No. 6,380,671 and U.S. Pat. No. 6,515,415.

With reference to FIG. 2, there is shown a field emission cathode device 6 in accordance with an alternative embodiment of the present invention. The field emission cathode device 6 includes a single cathode 61 having emitters 62 formed thereon, grid electrodes 64, 64′, and insulating layers 63 interposed between the cathode 61 and the grid electrodes 64, 64′. An isolated film 65 is formed on each pair of neighboring grid electrodes 64, 64′. All parts of coplanar surfaces of each pair of grid electrodes 64, 64′ and a surface 632 of the insulating layer 63 between the pair of grid electrodes 64, 64′ are covered by the isolated film 65. The isolated films 65 thus define apertures therebetween, the apertures corresponding to the emitters 62. In the illustrated embodiment, each isolated film 55 further covers surfaces of the grid electrodes 64, 64′ neighboring the emitters 62, and still further covers surfaces of the insulating layer 63 neighboring the emitters 62. A method for making the field emission cathode device 6 is similar to corresponding steps in the method for making the field emission display 5 described above, with due alteration of details.

It should be further noted that the field emission cathode device 6 can be coupled to an appropriate anode device in order to provide an integrated field emission device. For example, the field emission device obtained may be a field emission lamination device, a field emission display, or a field emission scanning microscope.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

1. A field emission device comprising:
a cathode electrode;
a plurality of emitters formed on the cathode electrode;
a plurality of grid electrodes formed over the cathode electrode at a distance apart from the emitters respectively; and
an isolated film commonly formed on first surfaces of each two neighboring grid electrodes.

2. The field emission device according to claim 1, wherein the isolated film has a thickness ranging from 0.1 to 1 microns.

3. The field emission device according to claim 1, wherein the isolated film is a film made of one or more insulating materials.

4. The field emission device according to claim 3, wherein the one or more insulating materials are selected from the group consisting of SiO₂ and Si₃N₄.

5. The field emission device according to claim 3, wherein the one or more insulating materials comprises one of more materials having a high secondary electron emission coefficient.

6. The field emission device according to claim 5, wherein the one or more materials having a high secondary electron emission coefficient are selected from the group consisting of MgO, Al₂O₃, and ZnO.

7. The field emission device according to claim 1, wherein the isolated film is further formed on second surfaces of each two neighboring grid electrodes, the second surfaces neighboring corresponding emitters.

8. The field emission device according to claim 1, wherein a material of the emitters is selected from the group consisting of carbon nanotubes, diamond, diamond-like carbon (DLC), and silicon.

9. The field emission device according to claim 1, wherein each of the emitters is made of a tip-shaped metal material.

10. The field emission device according to claim 1, further comprising an insulating layer between the cathode electrode and the grid electrode.

11. The field emission device according to claim 10, wherein the isolated film is further formed on a surface of the insulating layer between the two neighboring grid electrodes.

12. The field emission device according to claim 1, further comprising an anode electrode formed over the grid electrode and facing the cathode electrode.

13. A method for making a field emission device, the field emission device including a cathode electrode, a plurality of emitters formed on the cathode electrode, and a plurality of grid electrodes formed over the cathode electrode at a distance apart from the emitters respectively, the method comprising the step of:
commonly forming an isolated film on first surfaces of each two neighboring grid electrodes facing each other.

14. The method according to claim 13, wherein the forming step is performed by way of evaporation.

15. The method according to claim 13, wherein the evaporation comprises the step of spinning the grid electrodes.

16. The method according to claim 13, wherein evaporated molecules of a material of the isolated film shoot at surfaces of the grid electrodes at one or more oblique angles.

17. A field emission device comprising:
an electrifiable cathode electrode;
a plurality of emitters formed on said cathode electrode and electrically connected therewith so as to emit electrons therefrom;
an electrifiable anode electrode spaced from said plurality of emitters and capable of receiving said emitted electrons from said plurality of emitters;
at least two grid electrodes disposed between said plurality of emitters and said anode electrode, and spaced therefrom, said at least two grid electrodes arranged side by side and capable of being electrifiable to urge electrons-emission of said plurality of emitters; and
an isolated film covering more than one of said at least two grid electrodes so as to block accessibility of said electrons from said plurality of emitters toward said more than one of said at least two grid electrodes.
